(19) United States
(12) Patent Application Publication
(10) Pub. No.: US 2019/0003256 A1
(43) Pub. Date: Jan. 3, 2019

(54) A SYSTEM FOR PROVIDING A PRESSURIZED FLUID ON AND/OR IN A ROTATING PART OF THE SYSTEM

(71) Applicant: WEST DRILLING PRODUCTS AS, Stavanger (NO)

(72) Inventors: Odd B. Skjærseth, Stavanger (NO); Bjørn Eilertsen, Hundvåg (NO)

(73) Assignee: WEST DRILLING PRODUCTS AS, Stavanger (NO)

(21) Appl. No.: 15/735,897

(22) PCT Filed: Jun. 10, 2016
(86) PCT No.: PCT/IB2016/053436

§ 371 Date: Dec. 12, 2017

(30) Foreign Application Priority Data
Jun. 12, 2015 (NO) 20150770

(51) Int. Cl. E21B 3/04; F16H 1/22; F16H 7/06; F16H 7/02

(52) U.S. Cl. CPC E21B 3/04; F16H 7/02; F16H 7/06; F16H 1/22

(57) ABSTRACT

A system is described for providing a pressurized fluid on and/or in a rotatable part of the system. The system comprises at least a first part and a second part, the second part being rotatably supported relative to the first part about an axis A. The system further comprises a coupling element that is rotatably supported about the same axis A as the second part. Further, the first part comprises a first drive unit that is connected to the coupling element for rotation about the axis A, and the second part comprises a pressure-increasing device that is connected to the coupling element for driving the pressure-increasing device and regulating the drive speed of the pressure-increasing device.

The present application comprises a system for providing a pressurized fluid on and/or in a rotating part of the system, and is also directed to use of the system on a floating installation during the drilling of a borehole or in connection with the production of hydrocarbons.

In systems with rotating parts there may often be a need to have available a power source, such as a pressurized fluid and possibly electric power. Such a fluid is typically a hydraulic fluid that is used to drive one or more devices, valves and the like that are included in the rotating part. The pressurized fluid is traditionally transferred from a fixed area where necessary pumping equipment is located, to the rotating part through swivels. Transfer of the pressurized fluid through a swivel involves a risk of leakages and swivels are also costly devices that require regular maintenance to prevent leakage of fluid that is transferred through the swivel. Electric power is in such cases transferred by using slip rings, which also complicates the structure and results in an increased need for maintenance.

The object of the present invention has therefore been to develop a system or device which obviates the use of slip rings and one or more swivels for providing a pressurized fluid on or in a rotating part of a system or device.

This object is achieved by a system for providing a pressurized fluid on and/or in a rotating part of the system as defined in independent claim 1 and a use of the system as defined in claim 12. Additional embodiments of the invention are defined in dependent claims 2-11.

Accordingly, a system is provided for providing a pressurized fluid on and/or in a rotating part of the system. The system comprises at least a first part and a second part, the second part being rotatably supported relative to the first part about an axis A. The system further comprises a coupling element that is rotatably supported about the same axis A as the second part. Further, the first part comprises a first drive unit that is connected to the coupling element for rotation of the coupling element about the axis A, whilst the second part comprises a pressure-increasing device that is connected to the coupling element such that the coupling element can drive the pressure-increasing device and regulate the drive speed thereof.

The first part is preferably fixedly mounted in the system whilst the second part is able to rotate about an axis A relative to the first part and relative to the rest of the system. The pressure-increasing device is preferably fixedly mounted in the second part and rotates therefore at the same speed about the axis A as the second part of the system. If necessary, a plurality of pressure-increasing devices can of course be provided in the second part of the system, where each pressure-increasing device is connected to the coupling element.

The first drive unit thus determines the rotational speed of the coupling element about the axis A, whilst the rotational speed of the pressure-increasing device about the axis A is determined by the rotational speed of the second part. The drive speed of the pressure-increasing device is thus determined by the relative rotational speed between the coupling element and the second part, and desired drive speed of the pressure-increasing device can be obtained by adjusting the drive speed of the first drive unit that rotates the coupling element. By adjusting the rotational speed of the coupling element such that it is equal to the rotational speed of the second part, it is also possible to obtain a pressure device drive speed of zero even if the second part rotates.

This system provides mechanical operation of the pressure-increasing device without using swivels and slip rings and at the same time regulates the drive speed of the pressure-increasing device independent of the rotational speed of the second part, and thus independent of the rotational speed of the pressure-increasing device about the axis A.

The pressure-increasing device comprises preferably a pump or compressor, whilst the first drive unit comprises an electric or hydraulic motor, or optionally a pneumatic motor.

The first drive unit is preferably connected to the coupling element via at least one first power transmission element. Similarly, the coupling element is connected to the pressure-increasing device via at least one second power transmission element.

In one embodiment, the coupling element may comprise a gear rim that extends around the axis A in the circumferential direction. The first drive unit can then preferably be connected to the coupling element's gear rim via one or more gears, and the pressure-increasing device can preferably also be connected to the coupling element's gear rim via one or more gears. The first drive unit preferably comprises a drive shaft that can be provided with a gear capable of being in direct engagement with the gear rim on the coupling element. Alternatively, the gear on the drive shaft can be connected to the gear rim via one or more gears that are in engagement with the drive shaft gear and the coupling element's gear rim, such that when the first drive unit rotates the gear on the drive shaft, the coupling element is also rotated with the gear rim. The pressure-increasing device similarly comprises a driven shaft on which a gear may be provided that can be arranged in direct engagement with the gear rim on the coupling element. Alternatively, the gear on the driven shaft can be connected to the gear rim on the coupling element via one or more gears that are in engagement with the gear of the driven shaft and the coupling element's gear rim, such that when the first drive unit drives the coupling element, the driven shaft of the pressure-increasing device also rotates.

An alternative to using gears to drive the coupling element and the pressure-increasing device is to use drive belts or chains, where the first drive unit is connected to the coupling element by one or more drive belts or chains, and/or the pressure-increasing device is connected to the coupling element by one or more drive belts or chains. In practical terms, this can be done by running two drive belts or chains around the drive shaft and the coupling element in the same way as a bicycle chain runs around two sprockets. Similarly, a drive belt or a chain can extend around the driven shaft of the pressure-increasing device and the coupling element such that when the first drive unit drives the coupling element, the driven shaft of the pressure-increasing device also rotates.

The rotatable second part preferably comprises a cylindrical element on which the coupling element is rotatably supported. However, the coupling element need not be supported on the second part, but can also be rotatably supported on another part of the system provided that it is rotatable about the same axis A about which the second part of the system rotates.

The rotatable second part preferably also comprises a support element on which the pressure-increasing device is mounted. Optionally, as mentioned above, two or more pressure-increasing devices may be arranged on the support element.

The system preferably comprises a second drive unit for rotation of the second part. The system can further comprise a first gripping device and a second gripping device that are adapted to grip and hold tubular elements and/or a pipe string and/or a downhole device. The system described above is thus highly suitable for use on a floating installation during drilling of boreholes or in connection with the production of hydrocarbons.

Other features and advantages of the invention will be apparent from the following description of a preferred, non-limiting embodiment of the present invention, with reference to the figures, wherein:

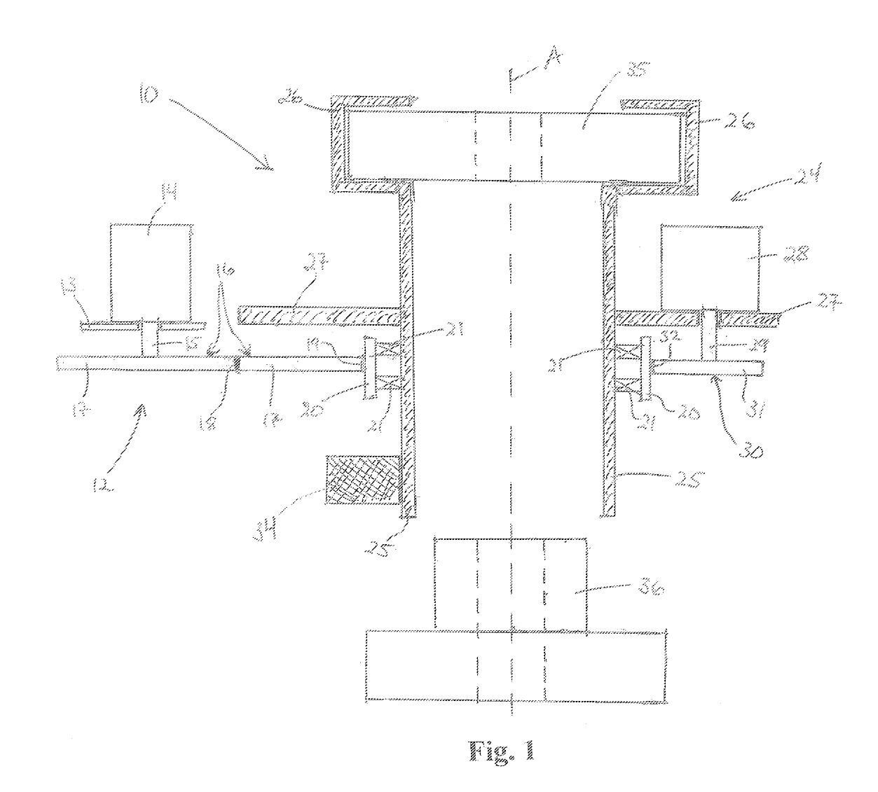

FIG. 1 is a schematic view of the present invention.

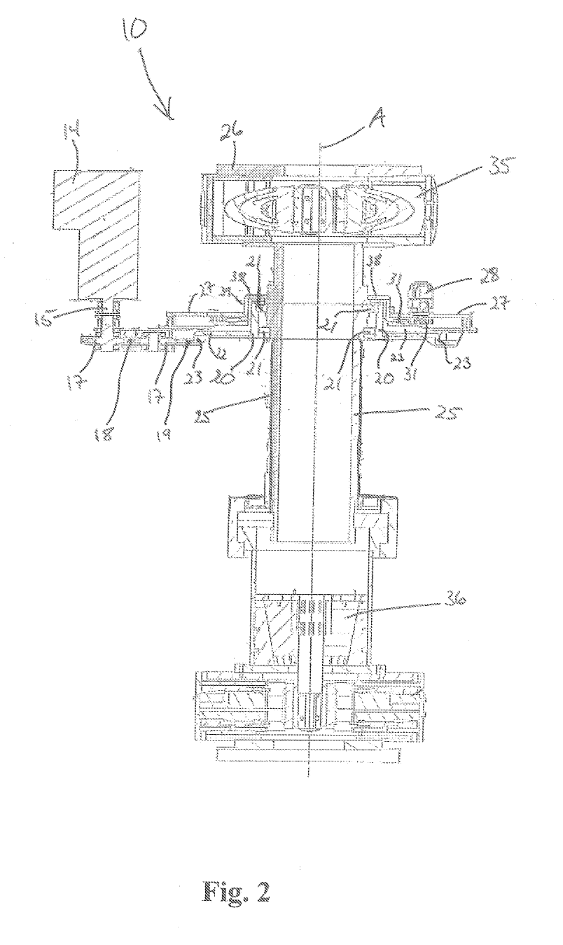

FIG. 2 shows an embodiment of the present invention.

It should first be mentioned that the same reference numerals have been used to designate the same technical features of the invention in FIGS. 1 and 2.

FIGS. 1 and 2 show in practice two embodiments of the invention which basically have the same technical features, but where FIG. 1 shows a simplified version of an actual embodiment of the invention as shown in FIG. 2. FIGS. 1 and 2 will therefore be described jointly below.

The figures show a system 10 comprising a first part 12 and a second part 24. The first part 12 can be rotatably arranged in the system, but is preferably fixedly arranged. The second part 24 is however rotatably arranged in the system about an axis A, as indicated in the figures.

The second part 24 comprises a basically cylindrical, rotatable element 25 and a housing 26 that is fastened to and rotates together with the rotatable element 25. The second part is further provided with a support element 27 which either can be directly fastened to the rotatable element 25, as shown in FIG. 1, or can be fastened to the rotatable element 25 via a plurality of plate elements 38, 39, as shown in FIG. 2. The support element 27 and the plate elements 38, 39 can be welded together or fastened to one another by means of bolts or other suitable fastening means. In addition, the assembly of the support element 27 and the plate elements is fastened to the rotatable element 25, preferably in that the plate element 39 is fastened to the rotatable element 25, such that when the rotatable element 25 is rotated, the support element 27 is also rotated.

On the support element 27 is arranged the pressure-increasing element 28, preferably mounted on the support element 27 by bolts or other suitable fastening means. As already indicated above, it is possible to arrange two or more pressure-increasing devices 28 on the support element 27, optionally on separate support elements arranged around the rotating element 25.

The system 10 further comprises a coupling element 20 which preferably, but not necessarily, is rotatably supported on the rotating element 25 about the same axis A as that about which the rotating element 25 rotates. The coupling element 20 can be supported by two bearings 21 as indicated in the figures. The coupling element 20 is thus freely rotatably mounted about the axis A relative to both the first part 12 and the second part 24.

The coupling element 20 may be a simple ring as indicated in FIG. 1, which preferably extends 360 degrees around the axis A. In the embodiment in FIG. 2, plate elements 22 and 23 are used in addition, which extend respectively in a radial direction relative to the axis A and in the axial direction relative to the axis A. The plate elements 22 and 23 can be fastened to each other by welding, with bolts or with the aid of other suitable fastening means. Similarly, the plate element 22 can be fastened to the ring 20 by welding, with bolts or with the aid of another suitable fastening means. The plate elements 22 and 23 will therefore be a part of the coupling element 20 and rotate together with the coupling element 20.

The coupling element 20 in the embodiment shown in the figures is provided with a gear rim (not shown in detail in the figures) which extends 360 degrees around the axis A. In FIG. 1, the gear rim is arranged directly on the coupling element 20 ring that extends around the rotating element 25, whilst in the embodiment in FIG. 2 the gear rim is arranged on the plate element 23. It should be stressed that in other embodiments of the invention, the coupling element 20 need not necessarily be provided with a gear rim. A solution without a gear rim will be explained in more detail below.

The first part 12 of the system comprises a support element 13 and a first drive unit 14 which is arranged on the support element 13 and mounted to the support element using bolts or other suitable fastening means.

The first drive unit 14 comprises a motor, for example, an electric or hydraulic motor, which drives the drive shaft 15 that projects from the first drive unit 14. The first part 12 further comprises two power transmission elements 16 in the form of gears 17, where one gear 17 is arranged on the drive shaft 15 of the first drive unit 14 whilst the other gear 17 is arranged such that it is in engagement with both the gear 17 mounted on the drive shaft 15, as indicated in the gear engagement area 18 in FIG. 1, and the gear rim on the coupling element 20, as indicated in the gear engagement area 19 in the figures. When the first drive unit 14 drives the drive shaft 15, the rotary motion will be transferred to the coupling element 20, which thus rotates about the axis A. It should be stressed that although the embodiment of the invention in the figures is provided with two gears 17, there is nothing to prevent only one gear 17 being used, i.e., that the gear mounted on the drive shaft 15 is in direct engagement with the gear rim on the coupling element 20; nor is there anything to prevent the use of three or more gears that are arranged in engagement with each other in such a way that when the drive shaft 15 is rotated, this will cause rotation of the coupling element 20 about the axis A. It is also worth noting that by using a motor 14 capable of rotating the drive shaft 15 both ways, the coupling element 20 can also be rotated both ways about shaft A. It is therefore possible to allow the coupling element 20 and the second part 24 of the system 10 to rotate in the same direction or in opposite directions depending on what is desirable at any given time.

The pressure-increasing device 28 preferably comprises a pump, or alternatively a compressor, for providing the pressurized fluid, where the pressure-increasing device 28 is provided with a driven shaft 29 that projects from the pressure-increasing device 28 as indicated in the figures. In the embodiments of the invention shown in the figures, a second power transmission element 30, in the form of a gear 31, is mounted on the driven shaft 29. In the embodiment of the invention shown in FIG. 1, the gear 31 mounted on the driven shaft 29 is arranged in direct engagement with the gear rim on the coupling element 20 as indicated in gear engagement area 32. In the embodiment of the invention shown in FIG. 2, two gears 31 are provided, where one gear 31 is mounted on the driven shaft 29, whilst the other gear 31 is arranged such that it is in engagement with both the gear 31 on the driven shaft 29 and the gear rim on the coupling element 20. It should be stressed that although the figures show only embodiments with respectively one and two gears for connecting the driven shaft 29 to the coupling element 20, there is of course nothing to prevent a larger number of gears from being used to transfer the rotary motion from the coupling element 20 to the driven shaft 29, should this be necessary.

It should now be clear that if the second part 24 of the system 10 remains at rest without rotating, it will still be possible to rotate the driven shaft 29, and thus drive the pressure-increasing device 28 and produce pressurized fluid by running the drive unit 14. The drive unit 14 will then rotate the coupling element 20 as described above, and the rotating coupling element 20 will drive the driven shaft 29 via the gears 31, and thus drive the pressure-increasing device 28.

When the second part 25, and thus the pressure-increasing device 28, rotates and the drive unit 14 is at rest such that the coupling element 20 is also at rest, the pressure-increasing device 28 will move around the gear rim of the coupling element 20, thereby causing rotation of the driven shaft 29. The drive speed of the shaft 29 will in this case be dependent upon the rotational speed of the second part 24. If another driven shaft 29 drive speed is required, or it is desirable to run at a constant speed even though the rotational speed of the second part 24 varies, the drive unit 14 can be used, where the drive speed of the drive shaft 15 is regulated such that the driven shaft 29 has a desired drive speed. By constantly regulating the drive speed of the drive shaft 15 relative to the rotational speed of the second part 24, it is possible also to obtain a constant drive speed of the driven shaft 29. The system 10 according to the present invention is therefore a very flexible solution where it is possible to provide a pressurized fluid on or in the rotating second part 24 of the system 10 without using swivels and/or slip rings, and at the same time regulate the drive speed of the pressure-increasing device 28 to a drive speed which is desirable at any given time.

In the embodiments in the figures, the first power transmission elements 16 and the second power transmission elements 30 are shown in the form of gears 17, 31. However there is nothing to prevent the use of other types of power transmission elements 16, 30 to transmit a torque from the drive shaft 15 to the coupling device 20 and from the coupling device 20 to the driven shaft 29. The power transmission elements 16, 30 can, for example, be in the form of chains that extend between and around sprocket elements on respectively the drive shaft 15 and the coupling element 20, and/or between and around sprocket elements on respectively the driven shaft 29 and the coupling device 20. Instead of chains, as an alternative, drive belts may be used that lie in suitable grooves in the drive shaft and coupling element and/or the driven shaft and coupling element.

In the housing 26, there may be provided a first holding device 35 that is capable of gripping and holding a tubular element and a pipe string, and preferably also a downhole tool such as the components of a bottom hole assembly (BHA). The system 10 preferably also comprises a second holding device 36 that is capable of gripping and holding a tubular element and a pipe string, and preferably also a downhole tool that is mounted on a pipe string. The system 10 is thus particularly suitable for use in drilling a borehole for hydrocarbons and subsequently in the production of hydrocarbons, where the system is able to provide a pressurized fluid in the rotating second part without the use of swivels and/or slip rings. The provided, pressurized fluid can, for example, be used to drive the first holding device 35 and/or one or more devices that are used in connection with the assembly of tubular elements on a pipe string or downhole tools on a pipe string.

1. A system for providing a pressurized fluid on and/or in a rotatable part of the system, which system comprises at least a first part and a second part,
wherein the second part is rotatably supported relative to the first part about an axis A,
wherein the system comprises a coupling element that is rotatably supported about the same axis A as the second part, that the first part comprises a first drive unit that is coupled to the coupled element for rotation of the coupling element about the axis A, and
wherein the second part comprises a pressure-increasing device that is connect to the coupling element, such that the coupling element can drive the pressure-increasing device and regulate the drive speed of the pressure-increasing device.

2. The system according to claim 1, wherein the first drive unit is coupled to the coupling element via at least one first power transmission element.

3. The system according to claim 1, wherein the coupling element is coupled to the pressure-increasing device via at least one second power transmission means.

4. The system according to claim 1, wherein the coupling element comprises a gear rim that extends around the axis A in the circumferential direction.

5. The system according to claim 4, wherein the first drive unit is coupled to the coupling element's gear rim via one or more gears and/or that the pressure-increasing device is coupled to the coupling element's gear rim via one or more gears.

6. The system according to claim 1, wherein the first drive unit is coupled to the coupling element by one or more drive belts or chains and/or that the pressure-increasing device is coupled to the coupling element by one or more drive belts or chains.

7. The system according to claim 1, wherein the rotatable second part comprises a cylindrical element on which the coupling element is rotatably supported.

8. The system according to claim 1, wherein the system comprises a second drive unit for rotation of the second part.

9. The system according to claim 1, wherein the pressure-increasing device comprises a pump or a compressor.

10. A system according to claim 1, wherein the first drive unit comprises an electric or hydraulic motor, or a pneumatic motor.

11. The system according to claim 1, wherein the system comprises a first gripping device and a second gripping device that are adapted to grip and hold tubular elements and/or a pipe string and/or downhole tools.

12. Use of the system according to claim 1 on a floating installation when drilling a borehole or in connection with the production of hydrocarbons.
